(19) United States
(12) Patent Application Publication
(10) Pub. No.: US 2009/0039541 A1
(43) Pub. Date: Feb. 12, 2009

(54) METHOD FOR PRODUCING COMPONENTS, ESPECIALLY STRUCTURAL PANELS, FROM SOLID WASTE

(76) Inventors: Gottfried Vom Orde, Schonaich (DE); Bernd Kiesel, Holzgerlingen (DE); Erwin W. Filler, Cudgera Creeck (AU)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/574,429

(22) PCT Filed: Jun. 29, 2005
(86) PCT No.: PCT/EP2005/006971

§ 371 Date: May 22, 2007

(30) Foreign Application Priority Data
Aug. 31, 2004 (DE) 10 2004-042 143.9

(51) Int. Cl. B29C 47/36

(52) U.S. Cl. 264/148; 366/348; 428/2; 106/638

(57) ABSTRACT

A method for manufacturing building elements, in particular building panels, from solid waste is described, in which the latter is provided, sorted according to category, in different fractions of a specified particle size. The different fractions are mixed in specified proportions with addition of water and binder. The resulting mixture is subjected to a continuous extrusion process, in which a strand-like preproduct is produced. Through a cutting operation, the desired dimensions of the building element in the extrusion direction are at least approximately produced. The building-element blanks are then dried and the binder present therein is set. This continuously working process is much more economical compared with the prior art and can be carried out on a large-scale industrial basis.

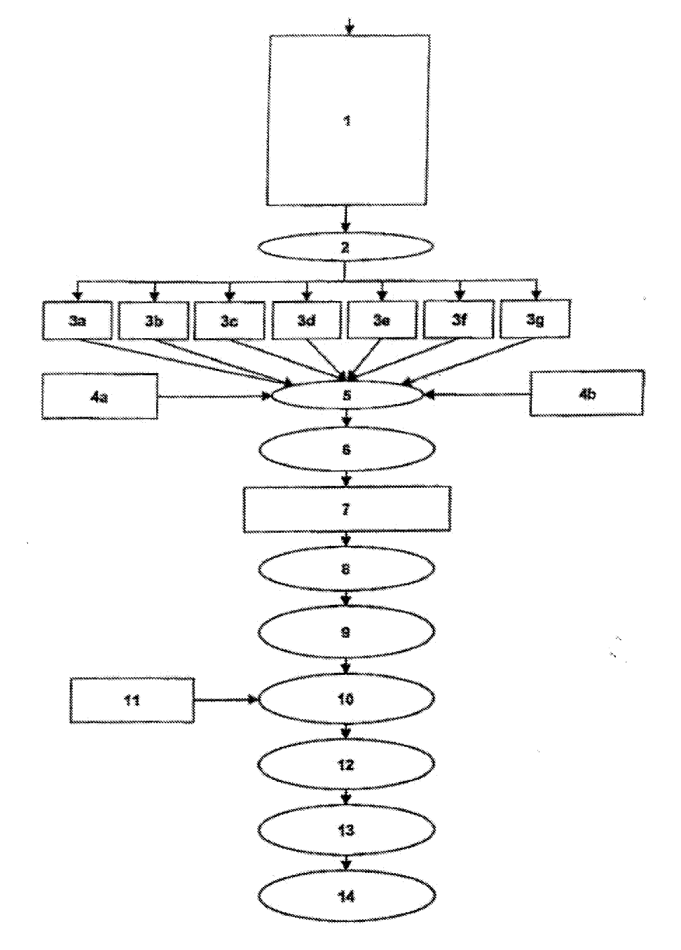

The invention relates to a method for manufacturing building elements, in particular building panels, from solid waste, in which
a) the solid waste is provided, sorted according to category, in different fractions of a specified particle size;
b) the different fractions are mixed in specified proportions with addition of water and binder;
c) the resulting mixture is subjected to a shaping process to obtain building-element blanks;
d) the building-element blanks are dried and the binder present therein is set.

Among the greatest problems of civilised society worldwide in this millennium are waste disposal, the recovery of raw materials from waste materials, the creation of housing and the creation of jobs. A holistic approach designed to at least alleviate these problems consists in manufacturing building elements from solid waste. The resulting building elements, in particular building panels, are not only relatively inexpensive and therefore enable economical creation of housing, but at the same time solve the problem of waste disposal to a certain extent. Jobs may also be provided in this way, particularly in less-developed countries.

At present, only a small part of the total solid waste produced is collected by regional organisations, sorted and then marketed as raw materials. Normally, the raw materials recovered as recycled material are separated into paper, rigid plastic, nonrigid plastic, film, glass and metal fractions and are delivered to respective product-specific, locally separated production facilities for further processing. The possible uses for these raw materials are fairly limited, however, so that the recycling of waste is still not extensive.

A method of the type mentioned at the outset is known from WO 98/30 330 A1. Here, the shaping process which converts the mixture of the solid-waste fractions into building-element blanks is a casting method. This discontinuous method is relatively expensive and is little suited to a large-scale industrial process. In the prior art, the particle size of the fractions added to the mixture is a few centimetres, and, in order to obtain good cohesion of the cast building-element blanks, must not fall below this size.

The object of the present invention is to specify a method of the type mentioned at the outset which can be carried out very inexpensively on a large-scale industrial basis.

This object is achieved in that
e) the shaping process comprises:
   ea) a continuous extrusion process, in which a strand-like preproduct is produced;
   eb) a cutting operation, in which the desired dimensions of the building element in the extrusion direction are at least approximately produced.

The method according to the invention can be carried out virtually continuously, since the extrusion employed as the shaping process takes place itself continuously. The continuous movement of the strand-like preproduct does not need to be interrupted even during the cutting operation, in which the strand is cut up into individual parts. The individual strand parts can then be separated by suitable acceleration, so that a specified distance is produced between them. Owing to the continuity of the method according to the invention and the high degree of automation which can be achieved with this method, the costs are relatively low. This of great importance particularly for use in less-developed countries where the building elements are to be employed for creating inexpensive housing.

The particle size of the fractions of solid waste should lie between 0.5 and 5 mm, i.e. should be markedly smaller than in the casting method according to the prior art. This smaller particle size not only increases the flowability of the mixture fed to the extrusion process, but also facilitates the conveyance of the individual fractions to temporary-storage bins or to the mixing apparatuses, since pneumatic conveying methods can be employed.

It is particularly preferred if the mixture fed to the extrusion process contains the following constituents:

| | |
|---|---|
| Constituents | Percent by mass |

| in dry matter | from | to |
|---|---|---|
| Additives | 0.1 | 5 |
| Building rubble | 0 | 30 |
| Fly ash | 20 | 50 |
| Glass | 0 | 30 |
| Rubber | 0 | 25 |
| Wood | 0 | 15 |
| Plastics | 0 | 10 |
| Paper | 0 | 8 |
| Textiles | 0 | 6 |
| Cement | 20 | 50 |
| Water | 25 | 35 |

The cutting operation expediently comprises a first rough cut, which is carried out on the strand-like preproduct leaving the extrusion process, and a fine cut, which produces the dimensional accuracy and is carried out on the dried building elements. In this way, account is taken of the fact that during the drying and setting process the building-element blanks undergo certain dimensional changes which cannot always be anticipated and are therefore corrected by the concluding fine cut.

If particularly inexpensive building elements are desired, the manufacturing method is thus completed. For more exacting requirements, however, the building elements can, finally, be coated on at least one side, thereby improving not only their optical properties but also their technical, physical and chemical properties.

The additives should contain methyl cellulose, which not only retains water in the mixture but also contributes considerably to the flowability and slidability of the mixture.

An exemplary embodiment of the invention is explained in more detail below with reference to the drawing; the single FIGURE shows a flowchart of the method according to the invention.

The method starts at step 1 with the reception of unsorted or sorted solid waste. The latter contains in particular building rubble, glass, rubber, wood, plastics, metal, paper and textiles. At step 2, the delivered material is processed into raw material. By this is meant the following: if the solid waste is delivered sorted, the processing of the raw material is confined to initial automatic loosening for expansion of the mostly compacted deliveries. Large parts are comminuted—optionally in two stages—until a particle size of 0.5 to 5.0 mm is attained.

If unsorted, i.e. mixed solid waste is delivered, automatic loosening again takes place first of all, followed by the automatic separation of large from small parts. The large parts are precomminuted. Then, the now handleable parts are presorted into the individual building rubble, glass, rubber, wood, plastics, paper and textiles fractions and thereafter comminuted, optionally in a fraction-specific manner, to the particle size of 0.5 to 5.0 mm required for subsequent production.

Both in the case of unsorted and sorted delivery of the solid waste, metallic parts are removed.

At step 3, the fractions thus brought to the required particle size are temporarily stored in different stores, the store 3a in the drawing standing for building rubble, the store 3b for glass, the store 3c for rubber, the store 3d for wood, the store 3e for plastics, the store 3f for paper and the store 3g for textiles.

At step 5, the individual fractions are mixed in specified proportions, certain additives and fly ash being added at step 4a and water and cement at step 4b. The additives mentioned are primarily methyl cellulose, which in the subsequent shaping process of the building elements improves the flow properties, retains the water and finally serves as a binder.

The mixing proportions are as follows:

Percent by mass

| Constituents in dry matter | from | to |
|---|---|---|
| Additives | 0.1 | 5 |
| Building rubble | 0 | 30 |
| Fly ash | 20 | 50 |
| Glass | 0 | 30 |
| Rubber | 0 | 25 |
| Wood | 0 | 15 |
| Plastics | 0 | 10 |
| Paper | 0 | 8 |
| Textiles | 0 | 6 |
| Cement | 20 | 50 |
| Water | 25 | 35 |

The resulting, well-mixed and homogenised mass is extruded to form a plate-shaped strand at step 6 and cut up into individual building elements, for example panels, at step 7. Step 8 denotes a continuous drying process, in which the early strength required for the subsequent finishing of the product is achieved. At step 9, finishing takes place, for example the fine trimming to produce dimensional accuracy or surface working.

With step 9, the method according to the invention is concluded for simple building elements. These are then appropriately made up, stored until final maturity and finally taken away to produce the end products, for example inexpensive houses.

More valuable building elements are subjected to a further treatment. For instance, they can be coated at step 10 with addition of coating substances (step 11) and dried. Thereafter, these products are also appropriately made up, stored and after the required maturation dispatched (steps 12 to 14).

1. Method for manufacturing building elements, in particular building panels, from solid waste, in which
(a) the solid waste is provided, sorted according to category, in different fractions of a specified particle size;
(b) the different fractions are mixed in specified proportions with addition of water and binder;
(c) the resulting mixture is subjected to a shaping process to obtain building-element blanks;
(d) the building-element blanks are dried and the binder present therein is set, characterized in that
(e) the shaping process comprises:
ea) a continuous extrusion process, in which a strand-like preproduct is produced;
eb) a cutting operation, in which the desired dimensions of the building element in the extrusion direction are at least approximately produced.

2. Method according to claim 1, characterized in that the particle size of the fractions of solid waste lies between 0.5 and 5 mm.

3. Method according to claim 1, characterized in that the mixture fed to the extrusion process contains the following constituents:
constituents in dry matter percent by mass

| | |
|---|---|
| constituents | percent by mass |
| in dry matter | from | to |
|---|---|---|
| additives | 0.1 | 5; |
| building rubble | 0 | 30; |
| fly ash | 20 | 50; |
| glass | 0 | 30; |
| rubber | 0 | 25; |
| wood | 0 | 15; |
| plastics | 0 | 10; |
| paper | 0 | 8; |
| textiles | 0 | 6; |
| cement | 20 | 50; and |
| water | 25 | 35. |

4. Method according to claim 1, characterized in that the cutting operation expediently comprises a first rough cut, which is carried out on the strand-like preproduct leaving the extrusion process, and a fine cut, which produces the dimensional accuracy and is carried out on the dried building element.

5. Method according to claim 1, characterized in that the building elements are, finally, coated on at least one side.

6. Method according to claim 1, characterized in that the additives contain methyl cellulose.
